(19) United States
(12) Patent Application Publication
(10) Pub. No.: US 2014/0265936 A1
(43) Pub. Date: Sep. 18, 2014

(54) BLOOD TRACKING FLASHLIGHT

(71) Applicant: FISKARS BRANDS, INC., Madison, WI (US)

(72) Inventors: Brian Matthew Unger, Hillsboro, OR (US); Brian H Nelson, Hillsboro, OR (US)

(73) Assignee: FISKARS BRANDS, INC., Madison, WI (US)

(21) Appl. No.: 13/802,263

(22) Filed: Mar. 13, 2013

(51) Int. Cl. F21K 99/00; H05B 33/08

(52) U.S. Cl. CPC F21K 9/50; H05B 33/0806
USPC 315/313; 362/231

(57) ABSTRACT

A blood tracking light includes a blue LED, a red LED, and a toggle switch that turns off the red LED when actuated, leaving the blue LED on.

### BACKGROUND

The present invention relates generally to the field of blood tracking. In particular, the present invention relates to a portable lighting unit configured to track blood using a light emitting diode (LED) illumination system.

There are occasions in which it is useful to be able to easily identify small amounts of blood in a particular environment. For example, a hunter may wound an animal, such as a deer, that runs some distance away from the hunter after being wounded. In such a case, the hunter would like to follow the blood trail in order to find the animal. Small drops of blood can be difficult to see on the ground and on foliage, especially in low light conditions. To aid the hunter, blood tracking systems have been devised that help differentiate the red color of the blood from the rest of the environment. Such systems include the utilization of special filters placed on flashlights and/or special goggles or glasses that highlight the blood.

It would be advantageous to provide a portable lighting device that gives the user true blood tracking capability in low-level lighting conditions by using the optical principle of color enhancement. In particular, it would be advantageous to provide a lighting device that gives a distinct visual appearance to blood without requiring special filters on a light source or requiring the user to wear special glasses or goggles.

### SUMMARY

One embodiment of the invention relates to a blood tracking light including a blue LED, a red LED, and a toggle switch that turns off the red LED when actuated, leaving the blue LED on.

Another embodiment of the invention relates to a blood tracking light including a first light source emitting blue light, a second light source emitting red light, and a toggle switch that turns off the second light source when actuated, leaving the first light source on.

Another embodiment of the invention relates to a blood tracking light including a blue LED, a red LED, and a toggle switch that automatically cycles the red LED off and on, leaving the blue LED on.

Alternative exemplary embodiments relate to other features and combinations of features as may be generally recited in the claims.

### BRIEF DESCRIPTION OF THE FIGURES

The invention will become more fully understood from the following detailed description, taken in conjunction with the accompanying drawings, in which:

FIG. 1 is a side view of a tracking device, according to an exemplary embodiment.

FIG. 2 is a bottom view of a tracking device, according to an exemplary embodiment.

FIG. 3 is a perspective view of a tracking device, according to an exemplary embodiment.

FIG. 4 is a rear view of a tracking device, according to an exemplary embodiment.

FIG. 5 is a front view of a tracking device, according to an exemplary embodiment.

FIG. 6 is an elevation view of a LED array, according to an exemplary embodiment.

FIG. 7 is an elevation view of a LED array, according to another exemplary embodiment.

FIG. 8 is an elevation view of a LED array, according to another exemplary embodiment.

FIG. 9 is an elevation view of a LED array, according to another exemplary embodiment.

FIG. 10 is an elevation view of a LED array, according to another exemplary embodiment.

FIG. 11 is an elevation view of a LED array, according to another exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Color perception cannot be attributed directly and solely to wavelengths of light. The eye focuses slightly differently on long wavelengths (reds) than on short wavelengths (blues). In one embodiment, a tracking device includes a multiple color light source having a red LED light beam and a blue LED light beam that creates an illusion causing the eye to see red objects in low level lighting conditions as bright red. Simultaneously illuminating a red blood spot with the red LED beam and the blue LED beam of the system creates the desired highlighted red blood effect. The highlighted blood appears red and the surrounding background green or brown flora appears blue/purple under the multi color LED beam even when the flora is wet.

In one embodiment, one or more blue LEDs (i.e. LEDs having a peak wavelength centered in the range of about 410 nm to about 500 nm) may be used with one or more red LEDs (i.e. LEDs having a peak wavelength in the range of about 600 nm to about 740 nm) to produce a spot that appears to be magenta to a user. In some embodiments, a LED having an output centered at about 425 nm may be used with an a LED having an output centered at about 625 nm. In another exemplary embodiment, a red LED having a wavelength centered around 628 nm and a blue LED having a wavelength centered around 470 nm may be used.

In some embodiments, the blood tracking system may include two LEDs (a red LED and a blue LED) that are simultaneously activated to provide the desired blood tracking effect. In other embodiments, additional LEDs are used to increase the brightness of the light source, such as two red LEDs and two blue LEDs, or even more LEDs, such as 3-6 red LEDs and 3-6 blue LEDs. The number of red LEDs may be greater or less than the number of blue LEDs. Also, the intensity of the red LEDs may be greater of less than that of the blue LEDs.

In an embodiment of the present disclosure, a tracking device utilizes three colors instead of two to provide a distinct visual appearance to blood. In particular, the tracking device utilizes one or more blue LEDs, one or more red LEDs, and one or more cyan LEDs. In an exemplary embodiment, the tracking device includes one blue LED, one red LED, and one cyan LED, the combination of which are capable of providing illumination sufficient for blood tracking purposes. In another embodiment, a single LED array is created with a blue LED die, red LED die, and cyan LED die. The use of the three colors is advantageous because the light beams from the three LEDs are easier to mix and focus into one beam. In the embodiment using the three discrete LEDs, the blue, red, and cyan LEDs may be focused and tuned to produce a homogenous spot using a lens that functions as a color mixer and focusing optic.

According to a preferred embodiment, the cyan LED has a peak wavelength of about 505 nm. The red and blue LEDs may have peak wavelengths in the ranges discussed above, but in a preferred embodiment the blue LED has a peak wavelength of about 470 nm and the red LED has a peak wavelength of about 630 nm.

The addition of the cyan LED is intended to aid in differentiating blood from yellow and brown materials that may reflect red light like blood does. For example, green leaves tend to absorb nearly all incident red light while fresh blood tends to reflect red light, causing the fresh blood to be highlighted relative to the blue illuminated background of green foliage (e.g., as illuminated by blue LED). However, yellow foliage (including flowers, seeds, dead or dried leaves that are yellow, brown, and/or shades of red, and other non-green forest materials) reflect red light to a much greater extent than green foliage. While fresh blood still reflects red light to a much greater extent than the yellow foliage, dried blood exhibits much less reflectivity of red light and can be difficult to distinguish from yellow folliage when only red and blue light sources are utilized in combination. Adding a cyan light source (e.g., a cyan LED) causes materials reflecting red light that are not blood (e.g., yellow foliage) to reflect yellow (e.g., cyan) light, thereby illuminating these objects as yellow and making them easier to distinguish from blood.

The intensity of the individual light sources in the tracking device may be varied to improve the highlighting of blood. In the three color embodiments discussed below, when the tracking device is activated, the luminous intensity (candelas) of the blue and cyan light sources may be greater than the intensity of the red light source. In one embodiment, the number of blue and cyan LEDs is greater than the number of red LEDs to provide the greater intensity of the blue and cyan light sources. In another embodiment, more current is provided to the blue and cyan LEDs to increase their intensity relative to the red LED. In a preferred embodiment, the intensity of the blue and cyan light sources is approximately the same and both have an intensity much greater than that of the red light source. For example, the ratio of the intensity of either the blue LED or the cyan LED to the intensity of the red LED may be ten to one in one embodiment. The increased intensity of the blue LED and the cyan LED relative to the red LED may be accomplished via the selection of appropriate LED sizes or providing the necessary forward current to the LEDs to accomplish the intensity differential.

Some of the LEDs may be toggled on and off to further aid blood tracking. For example, a tracking device with a red LED light beam, blue LED light beam, and cyan LED light beam may illuminate an area including a red blood spot, resulting in the highlighted blood appearing red and the surrounding area appearing blue. The user may then toggle the red LED on and off. By toggling the red LED, the blood is more distinguishable compared to the surrounding areas than when constantly illuminated by the red, blue, and cyan LEDs due to the instantaneous adjustment of red light relative to a gradual adjustment of blue light. The embodiments of the present disclosure describe a tracking device that allows the user to toggle the red LED manually, or automatically based on a timing mechanism of the blood tracking device.

In another embodiment, the red LED may be pulsed at a particular frequency, which, when combined with the steady output of the blue LED, can enhance the visual signature of the blood or other red material being tracked.

In some embodiments, the LEDs may be used individually, to provide either red output, blue output, or cyan output separately. In other embodiments, other LEDs may be added to the system, including other LEDs having different colors or wavelengths, such as infrared wavelengths. Circuitry may be utilized to provide different lighting options of the various LEDs and combinations of LEDs.

In an exemplary embodiment, the blood tracking system is incorporated into a portable light source, such as a handheld flashlight or a headlamp flashlight. The headlamp may have a removable, adjustable headband. The headlamp may utilize a single AAA battery to provide power to the LEDs. Alternatively, multiple batteries may be used and the batteries may be of various sizes and types. The blood tracking system may be utilized in other portable light sources such as handheld flashlights and lanterns.

Referring to FIGS. 1-5, according to an exemplary embodiment, tracking device 10 includes a housing with a handle 12, and a head 14. Handle 12 includes a grip portion 16 and a power switch 18. Head 14 and handle 12 are shown coupled to each other and may be formed as a single unitary body. Alternatively, head 14 and handle 12 may be coupled at other angles or in-line such that the head and handle extend along either the same longitudinal axis, or along longitudinal axes that are substantially parallel. In yet another embodiment, head 14 may be rotatably coupled to handle 12 to allow a user to adjust the angle formed by head 14 and handle 12.

Handle 12 includes a grip portion 16 that includes grooves 17 for the fingers of a user to contact while using tracking device 10. Handle 12 is shown as being generally straight along a longitudinal axis. Alternatively, other ergonomic configurations including a curved handle may be used. Handle 12 may include a removable cover 26 which may cover a battery compartment. Tracking device 10 may be configured to run on batteries or may be adaptable to be used with alternating or direct current from an external power source.

Head 14 may include a light source. The light source may be multiple LEDs, such as red LEDs, blue LEDs, and cyan LEDs as described in the present disclosure. Head 14 may additionally include other light sources such as a xenon bulb, other type of incandescent bulb, other colored LEDs, etc. Head 14 may include a reflector that may be generally parabolic in shape to direct light emitted into a beam.

The light source may include an LED array, such as those shown in FIGS. 6-11. Any greater or lesser number of LEDs in other configurations may also be used. The LED array is controlled by power switch 18 and the toggle switch 20. For example, power switch 18 may control the LED array by turning on and off all of the LEDs at once, and toggle switch 20 may turn some of the LEDs on and off. Power switch 18 may further activate and deactivate other non-LED light sources in tracking device 10, deactivate the other light sources and activate the LED array simultaneously, etc.

In some embodiments, tracking device 10 may optionally include a power indicator, that may be used to indicate the strength of batteries used to power tracking device 10. Tracking device 10 may further include any other elements common to a portable lighting device without departing from the scope of the present disclosure.

Referring generally to FIGS. 6-11, various LED array embodiments are shown. The LED array embodiments illustrated are provided as examples only and should not be regarded as limiting. For example, while the embodiment of FIG. 6 illustrates eight LEDs in a LED array, the LED array may include more or fewer LEDs, and may include any number of red LEDs, blue LEDs, and cyan LEDs.

Referring to FIG. 6, LED array 40 includes a total of eight LEDs 42. According to one embodiment, LEDs 42 may be a combination of red LEDs, blue LEDs, and cyan LEDs. In another embodiment, LEDs 42 may be a combination of red LEDs and blue LEDs. In one embodiment, there may be more blue LEDs and cyan LEDs than red LEDs (e.g., three blue LEDs and three cyan LEDs compared to two red LEDs).

Referring to FIG. 7, LED array 40 includes a total of six LEDs 44. According to one embodiment, LEDs 44 may include two red LEDs, two blue LEDs, and two cyan LEDs. In other embodiments, more or less red, blue, and cyan LEDs may be included.

Referring to FIG. 8, LED array 40 may include LED dies (e.g., components made of a semiconductor material used to generate light in a LED). According to an exemplary embodiment, one or more red LED dies 46, one or more blue LED dies 48, and one or more cyan LED dies 50 may be used together. The LED dies may be focused and tuned to produce a homogenous blue spot.

Referring to FIG. 9, the LED array may include a tricolor LED 52. According to one embodiment, one or more red emitter outputs 54, one or more blue emitter outputs 56, and one or more cyan emitter outputs 58 may be used together. The LED emitter outputs may be focused and tuned to produce a homogenous blue spot.

Referring to FIG. 10, a LED array 60 may include a LED 62 configured to emit an output that is a combination of red, blue, and cyan wavelengths. Referring to FIG. 11, a white LED 66 may be used with a filter 68 in LED array 64. Filter 68 may absorb light while transmitting, balancing the red, blue, and cyan light to create an appropriate beam. Alternatively, a plurality of filters may be used to create the beam. In some embodiments, a plurality of light sources, such as white LEDs, may be used with filters. For example, one lights source including one or more white LEDs and a blue filter may be used with a second light source including one or more white LEDs and a red filter and a third light source including one or more white LEDs and a cyan filter.

As a further alternative, variable color LEDs (e.g., RGB LEDs) may be utilized along with a controller (e.g. a pulse width modulation controller) configured to control the emitted colors or intensities of the variable color LEDs to provide the blue, red, and cyan light sources that are combined to highlight blood.

Toggle switch 20 may be used to toggle off and on one or more LEDs in the LED arrays as shown in FIGS. 6-11 or otherwise. In one embodiment, when a user activates toggle switch 20 (e.g., when the switch is depressed or engaged), tracking device 10 goes from a state where all LEDs are on to a state where any red LEDs are off, leaving just the blue LEDs (and any other non-red LEDs) on. The deactivation and subsequent reactivation of the red LEDs enhances the view of blood to a user, as the blood stands out more due to the abrupt change in lighting as compared to constant illumination from the blue and red LEDs (and any other LEDs of other colors).

In one embodiment, after the user activates toggle switch 20, the user may activate toggle switch 20 a second time to turn back on the red LEDs (e.g., a latching switch). In another embodiment, after the user actuates toggle switch 20 to turn off the red LEDs, the red LEDs turn on when user stops actuating toggle switch 20 (e.g. an instantaneous switch). In yet another embodiment, after the user activates toggle switch 20, the red LEDs automatically turn off and on. In some embodiments, the off and on cycles are of equal duration. In other embodiments, the off and on cycles are of unequal duration.

In one embodiment, toggle switch 20 may be used to toggle on and off the red LEDs and the cyan LEDs, leaving the blue LEDs continuously on.

While tracking device 10 and toggling feature is described in the present disclosure with reference to a three color (red LED, blue LED, and cyan LED) embodiment, in other embodiments, the toggling feature may be implemented with various other color configurations of tracking device 10. For example, the toggling feature may be used in a tracking device with a red LED and blue LED (e.g., toggling the red LED on and off).

The tracking device has several potential uses in addition to use in the hunting context described above. For example, the system may have several potential military uses, such as by medics to determine the source of blood on a body that is covered by dirt, mud, or other material obscuring the wound providing the source of blood. Further, special forces personnel may utilize the invention to track enemy combatants that may have been wounded and are providing a blood trail. Also, the tracking device may be used by forensic analysts to find blood.

While the detailed drawings and specific examples given describe various exemplary embodiments of the blood tracking system, they serve the purpose of illustration only. It is to be understood that the invention is not limited in its application to the details of construction and the arrangements of components set forth in the preceding description or illustrated in the drawings. For example, other arrangements of LEDs may be used to create the desired blood tracking effect, or the flashlight may be one of a variety of configurations known in the art. Furthermore, other substitutions, modifications, changes, and omissions may be made in the design, operating conditions, and arrangements of the exemplary embodiments without departing from the scope of the invention as expressed in the appended claims

What is claimed is:

1. A blood tracking light, comprising:
a blue LED;
a red LED; and
a toggle switch that turns off the red LED when actuated, leaving the blue LED on.

2. The blood tracking light of claim 1, further comprising:
a power switch that turns the blue LED and the red LED on or off when actuated.

3. The blood tracking light of claim 2, wherein the toggle switch comprises a latching switch.

4. The blood tracking light of claim 2, wherein the toggle switch comprises an instantaneous switch.

5. The blood tracking light of claim 1, wherein the blue LED has a peak wavelength in the range of about 410 nm to about 500 nm.

6. The blood tracking light of claim 1, wherein the red LED has a peak wavelength in the range of about 600 nm to about 740 nm.

7. The blood tracking light of claim 1, further comprising a cyan LED.

8. The blood tracking light of claim 7, wherein the cyan LED has a peak wavelength of about 505 nm.

9. A blood tracking light, comprising:
a first light source emitting blue light;
a second light source emitting red light; and
a toggle switch that turns off the second light source when actuated, leaving the first light source on.

10. The blood tracking light of claim 9, further comprising:
a power switch that turns the first light source and the second light source on or off when actuated.

11. The blood tracking light of claim 10, wherein the toggle switch comprises a latching switch.

12. The blood tracking light of claim 10, wherein the toggle switch comprises an instantaneous switch.

13. The blood tracking light of claim 9, wherein the first and second light sources are LEDs.

14. The blood tracking light of claim 9, wherein the first and second light sources are variable color LEDs.

15. A blood tracking light, comprising:
a blue LED;
a red LED; and
a toggle switch that automatically cycles the red LED off and on, leaving the blue LED on.

16. The blood tracking light of claim 15, further comprising:
a power switch that turns the blue LED and the red LED on or off when actuated.

17. The blood tracking light of claim 16, wherein the off and on cycles of the red LED are of equal duration.

18. The blood tracking light of claim 16, wherein the off and on cycles of the red LED are of unequal duration.

19. The blood tracking light of claim 15, wherein the blue LED has a peak wavelength in the range of about 410 nm to about 500 nm.

20. The blood tracking light of claim 15, wherein the red LED has a peak wavelength in the range of about 600 nm to about 740 nm.
